(19) United States
(12) Patent Application Publication
(10) Pub. No.: US 2026/0033428 A1
(43) Pub. Date: Feb. 5, 2026

(54) SUGARCANE HARVESTER INCLUDING A CLEANING SYSTEM HAVING CONVERGING-DIVERGING NOZZLES

(71) Applicant: DEERE & COMPANY, Moline, IL (US)

(72) Inventors: Justin James Morgan, Schriever, LA (US); Blain J. Cazenave, Vacherie, LA (US); John A. Dighton, Napoleonville, LA (US)

(21) Appl. No.: 18/792,165

(22) Filed: Aug. 1, 2024

(51) Int. Cl. A01D 45/10

(52) U.S. Cl. CPC A01D 45/10

(57) ABSTRACT

A cleaning arrangement for separating a billet material from extraneous plant matter in a sugarcane harvester includes a cleaning chamber defining an inlet for the billet material and the extraneous plant matter, a first outlet for the extraneous plant matter, and a second outlet defined in a basket for the billet material. A fan is positioned within the cleaning chamber and configured to generate an airflow to direct the extraneous plant matter toward the first outlet. A supplemental air attachment is positioned to direct an accelerated airflow of air toward the louver to separate the extraneous plant matter from the crop billets.

### FIELD OF THE DISCLOSURE

The present disclosure relates to a sugarcane harvester and more particularly to a cleaning arrangement of a sugar cane harvester that assists in separating sugarcane billets from crop residue including leaves, dirt, and other trash.

### BACKGROUND

A sugarcane harvester severs sugarcane plants from the ground with a base cutter assembly and transports the severed plants to a set of chopping drums that chop the severed plant into billets. The billets are sent through a cleaning arrangement to separate the billets from non-billet material, i.e. crop residue, such as leaves, dirt, and other trash. Passing through the cleaning system, the billets are then discharged, for example, from the harvester to be transported by or stowed in a vehicle.

### SUMMARY

In one implementation, there is provided a sugarcane harvester for harvesting a sugarcane crop including stalks of sugarcane. The sugarcane harvester includes a chopper configured to chop the sugarcane crop into crop billets for discharge into a cleaning chamber. A primary separator includes a housing and a fan positioned in the housing to induce a primary flow of air to separate extraneous plant matter from the crop billets, wherein the housing includes a housing inlet through which the primary flow of air enters the housing. A louver is located in the housing to deflect the crop billets into a basket. A supplemental air attachment is located in the housing opposite of the chopper and configured to direct an accelerated flow of air towards the louver to separate the extraneous plant matter from the crop billets.

In some implementations the sugarcane harvester includes wherein the supplemental air attachment is coupled to the louver.

In some implementations the sugarcane harvester includes wherein the supplemental air attachment is coupled to the basket.

In some implementations the sugarcane harvester includes wherein the supplemental air attachment is coupled at a periphery of the basket.

In some implementations the sugarcane harvester includes wherein the supplemental air attachment includes one or more converging-diverging nozzles, each of which discharges the accelerated air flow.

In some implementations the sugarcane harvester includes wherein the accelerated air flow is a supersonic airflow delivered at an outlet of the one or more converging-diverging nozzles.

In some implementations the sugarcane harvester includes wherein each one of the one or more converging-diverging nozzles is independently controlled between an off state where no air flow is delivered from the outlet converging-diverging nozzle and on state where the accelerated air flow is delivered from the outlet of the converging-diverging nozzle.

In some implementations the sugarcane harvester includes wherein each of the one or more converging-diverging nozzles is independently controlled between an off state where no air flow is delivered from the outlet converging-diverging nozzle and an on state where the accelerated air flow is delivered from the outlet of the converging-diverging nozzle.

In some implementations the sugarcane harvester includes wherein each of the one or more converging-diverging nozzles is independently controlled to deliver accelerated air flows having different velocities.

In some implementations the sugarcane harvester includes wherein the louver includes a plurality of sensors to detect billet impacts and a controller adjusts the accelerated air flow of one or more of the nozzles based on the detected billet impacts.

In another implementation, there is provided a cleaning system for a sugarcane harvester. The cleaning system includes a primary separator comprising a housing and a fan for providing a primary flow of air into the housing, wherein the housing includes an opening defined at a front portion thereof configured to receive a crop billet mat that is chopped by a chopper and discharged into the housing along a first flow path. A billet deflector is located in the housing adjacent the opening, wherein the billet deflector is configured to deflect the crop billet from the first flow path to a second flow path. A louver is located in the housing and along the second flow path, wherein the louver is configured to redirect the crop billet from the second flow to a third flow path in the housing. A basket is located in the housing and at a location below the louver, wherein the basket is positioned along the third flow path to receive the crop billets from the louver. A supplemental air attachment is located in the housing and is configured to direct an accelerated flow of air towards the crop billet mat to separate the extraneous plant matter from the crop billets.

In some implementations the cleaning system includes wherein the supplemental air attachment is coupled to the louver.

In some implementations the cleaning system includes wherein the supplemental air attachment is coupled to the basket.

In some implementations the cleaning system includes wherein the supplemental air attachment is coupled at a periphery of the basket or to an elevator.

In some implementations the cleaning system includes wherein the supplemental air attachment includes one or more converging-diverging nozzles, each of which discharges the accelerated air flow.

In some implementations the cleaning system includes wherein the accelerated air flow is a supersonic airflow delivered at an outlet of the one or more converging-diverging nozzles.

In some implementations the cleaning system includes wherein each one of the one or more converging-diverging nozzles is independently controlled between an off state where no air flow is delivered from the outlet converging-diverging nozzle and on state where the accelerated air flow is delivered from the outlet of the converging-diverging nozzle.

In some implementations the cleaning system includes wherein each of the one or more converging-diverging nozzles is independently controlled between an off state where no air is delivered from the outlet converging-diverging nozzle and an on state where the accelerated air flow is delivered from the outlet of the converging-diverging nozzle.

In some implementations the cleaning system includes wherein each of the one or more converging-diverging nozzles is independently controlled to deliver accelerated air flows having different independently controlled nozzle orientations.

In some implementations the cleaning system includes wherein the louver includes a plurality of sensors to detect billet impacts and a controller adjusts the accelerated air flow of one or more of the nozzles based on the detected billet impacts.

### BRIEF DESCRIPTION OF THE DRAWINGS

FIG. 1 is a side view of a sugarcane harvester.

FIG. 2 is a cross-sectional side view of a portion of the sugarcane harvester of FIG. 1.

FIG. 3 is a perspective side view of a portion of the sugarcane harvester having a louver with an air attachment.

FIG. 4 is a front view of a louver with sensors.

FIG. 5 is a front view of an air supply with nozzles directed to a louver with sensors located beneath a primary separator.

FIG. 6 is a front view of a louver with sensors and with an air attachment having converging-diverging nozzles directed to the louver.

FIG. 7 is a front view of an air attachment including converging-diverging nozzles.

FIG. 8 is a cross-sectional view of one implementation of a converging-diverging nozzle to separate extraneous plant matter from crop billets.

FIG. 9 is a cross-sectional view of another implementation of a converging-diverging nozzle to separate extraneous plant matter from crop billets.

FIG. 10 is an elevator transition system.

FIG. 11 is a perspective side view another implementation of a cleaning system.

FIG. 12 is a front schematic view of a portion of a cleaning system.

FIG. 13 illustrates a schematic representational view of airflow generated by nozzles of the charged air attachment.

FIGS. 14A-14C illustrate additional implementations of supersonic nozzles.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

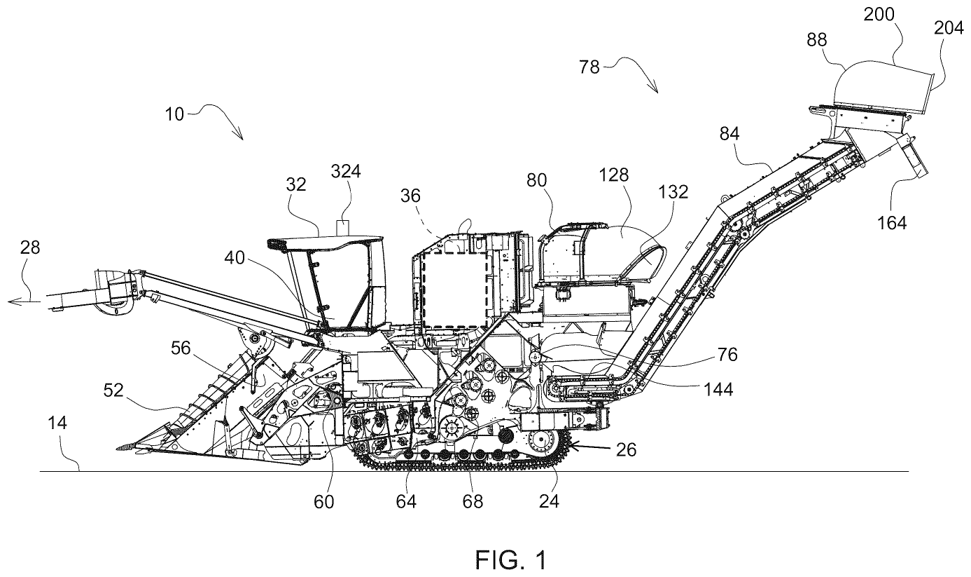

FIG. 1 illustrates a side view of a harvester 10, such as a sugarcane harvester, configured to harvest crop from a field 14. The illustrated harvester 10 includes a main frame 20 supported on one or more ground-engaging mechanisms such as wheels 24 or tracks that engage the field 14 in order to move the harvester 10 across the field 14 in a direction of travel 28. In some implementations, the wheels 24 may include continuous tracks 26 or other traction devices. An operator's cab 32 is mounted on the frame 20 above a prime mover 36, such as an engine. The prime mover 36 may be an internal combustion engine or other such device for providing motive power. The harvester 10 includes a throttle control 40 (e.g., a lever, button, switch, pedal, etc.) for controlling a speed of the prime mover 36 and thus a speed of the harvester 10 (also referred to as the harvester speed). The harvester 10 includes a pair of crop lifters 52 mounted to the front of the frame 20, defining an inlet 56 for receiving the crop.

The crop lifters 52 cooperate with a knockdown roller 60 and a base cutter 64 to remove the crop from the field 14. Feed rollers 68 are disposed within the inlet 56 to feed the crop from the field 14 into the harvester 10. The feed rollers 68 operate at a feed speed. The harvester 10 further includes a chopper 76, and a cleaning arrangement or cleaning system 78 (also referred to herein as residue discharge system) including a primary separator 80 and/or a secondary separator 88. The harvester 10 also includes a conveyor 84 (also referred to herein as an elevator) connecting the primary separator 80 and the secondary separator 88.

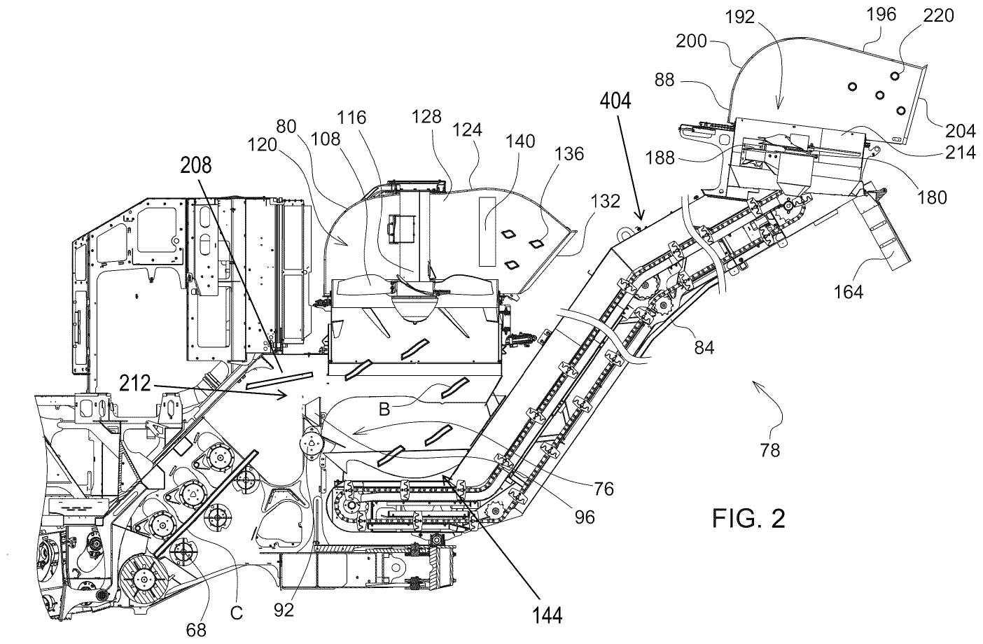

FIG. 2 illustrates the chopper 76 and the cleaning system 78 in more detail. The chopper 76 is disposed adjacent the c The chopper drums 92 include a blade 96 for cutting the stalks of the crop. In one implementation, the chopper 76 may include counter rotating drum cutters with overlapping blades. In other implementations, the chopper 76 may include any suitable blade or blades for cutting the stalks of crop. The chopper 76 cuts the stalks of crop, referred to as cane C, into crop billet B, which includes pieces of the stalk. The crop also includes dirt, leaves, roots, and other plant matter, which is collectively referred to herein as extraneous plant matter, or crop residue.

The chopper 76 operates at a chopper speed, which may be adjusted to change a size and weight of the resulting chopped crop pieces. The chopper 76 directs a stream of the cut crop, including crop billets B and extraneous plant matter, to the cleaning system 78 and specifically to the primary separator 80. In one implementation, a deflector 208 is disposed at an outlet of the chopper 76 and at a housing inlet 212. The billet deflector 208 is positioned within a flow path of the material entering the primary cleaning chamber 120 such that the material, such as the crop billet material B, impacts the billet deflector 208 and is physically redirected by the contact. The physical contact between the material and the billet deflector 208 (impacting the billet deflector 208 and moving across the billet deflector 208) directs the crop across the cleaning chamber and additionally promotes separation of the billet material B from the extraneous plant matter.

The cleaning system 78 is generally configured to distinguish between the billet B and the extraneous plant matter. (The extraneous plant matter may be referred to herein as residue, especially when ejected from the cleaning system 78). The cleaning system 78 is generally operable at an adjustable cleaning speed. The primary separator 80 is coupled to the frame 20 and disposed downstream of the chopper 76 for receiving cut crop from the chopper 76. The primary separator 80 generally separates the extraneous plant matter from the crop billet B by way of any suitable mechanism for cleaning the cut crop, such as a fan, a source of compressed air, a rake, a shaker, or any other mechanism that distinguishes various types of crop parts by weight, size, shape, etc. in order to separate extraneous plant matter from crop billet. In the illustrated implementation, the primary separator 80 includes a primary fan 108 driven at a primary fan speed by a primary motor 116. The primary fan speed can be varied by controlling the primary motor 116. Thus, in the illustrated implementation, the cleaning speed may include the primary fan speed, however in other implementations, the cleaning speed may include air speed (e.g., of released compressed air or any other pressurized air), rake speed, shaker speed, etc. The primary separator 80 further includes a primary cleaning chamber 120 generally defined by a primary cleaner housing 124.

The primary separator 80 includes a primary hood 128 coupled to the main frame 20. The primary hood 128 may have a domed shape, or other suitable shape, and includes a primary opening 132 (also referred to herein as first outlet) angled out from the harvester 10 and facing slightly down towards the field 14. The hood directs separated extraneous plant matter through the primary opening 132 to the outside of the harvester, back onto the field 14. In some implementations the primary separator 80 includes a primary shredder 140 that shreds the residue into smaller pieces (primary residue 136), which can be selectively activated by an operator. The separated crop, including mostly crop billet B, is directed to an outlet of the cleaning chamber 120 and is deposited in a basket 144 disposed below the primary separator 80.

With continued reference to FIG. 2, the conveyor 84 is coupled to a rear of the frame 20 for receiving the separated crop from the basket 144. The conveyor 84 extends from the rear of the harvester 10 and terminates at a discharge opening 164 (also referred to herein as a second outlet) elevated to a height suitable for discharging cleaned crop into a vehicle. The second outlet 164 does not discharge the harvested material to the field, like the first outlet, but instead discharges the material to a collection vehicle. The secondary separator 88 is disposed adjacent the discharge opening 164 for cleaning the crop a second time before being discharged into the vehicle. The secondary separator 88 may include a fan, a compressed air source, a rake, a shaker, or other suitable device. In the illustrated implementation, the secondary separator 88 includes a secondary fan 180 driven at a secondary fan speed by a secondary motor 188. The secondary separator 88 includes a secondary cleaning chamber 192 defined by a secondary cleaner housing 196. The secondary cleaner housing 196 includes a secondary hood 200 having a secondary opening 204. The secondary crop cleaner is operable such that additional extraneous plant matter is discharged through the secondary opening 204 and the remaining separated crop is discharged through the discharge opening 164 and into the vehicle. In some implementations, the secondary separator 88 includes a secondary shredder 214 that shreds the residue into smaller pieces (secondary residue 220), which can be selectively activated by the operator.

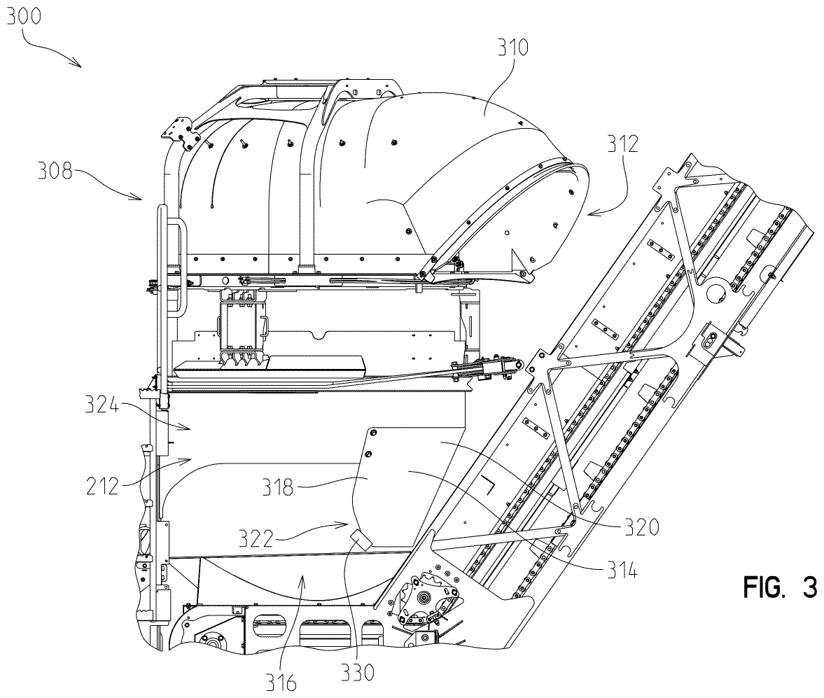

FIG. 3 illustrates an implementation of a cleaning system 300. The cleaning system 300 includes a primary separator 308 having a hood 310 and defining a primary opening 312. The cleaning system 300 includes a rear deflector, herein referred to as a louver 314. The louver 314 may be positioned on an opposite side of the cleaning system 300 from the chopper 76, and the louver 314 may be positioned at least partially lower than the housing inlet 212 to prevent billets from overshooting a basket 316. The louver 314 may have a front surface 318 and a rear surface 320 with one or more sensors 322 coupled to the front surface 318 to detect billet impact. The louver 314 may be removably coupled to the cleaning system 300. In one implementation, the louver 314 may be removably coupled to the exterior of a primary cleaner housing 324, however the louver 314 may also be coupled to the interior of the primary cleaner housing 324. The louver 314 may be positioned within the flow path of a material, such that the material, such as crop billet B, impacts the louver 314 and is physically redirected by the contact. The physical contact between the material and the louver 314 may direct the material to the basket 316. More specifically, the material may impact the one or more sensors 322 coupled to the louver 314.

The one or more sensors 322 may be coupled to a power source. In one implementation, the power source may be a battery, such as, for example, a hardwired connection to a battery of the harvester 10. In another implementation, the power source may be piezoelectric energy harvesting, thermoelectric energy harvesting, solar power, wind power, or any other method of generating power to a sensor known in the art. In one implementation the one or more sensors 322 may be a mass flow sensor and the one or more sensors 322 may detect crop material that has impacted the one or more sensors 322. After impacting the one or more sensors 322, the material may subsequently be directed into the basket 316. In some examples, the one or more sensors 322 may include one or more of accelerometers, pressure bladders, strain gauges, piezo microphones, reed switches, threshold detectors, frequency key matching sensors, frequency filtering sensors, time at level sensors, neural nets, capacitive sensors, electromagnetic near field interference sensors, impact plates, force plates, load cells, or any other sensors known in the art.

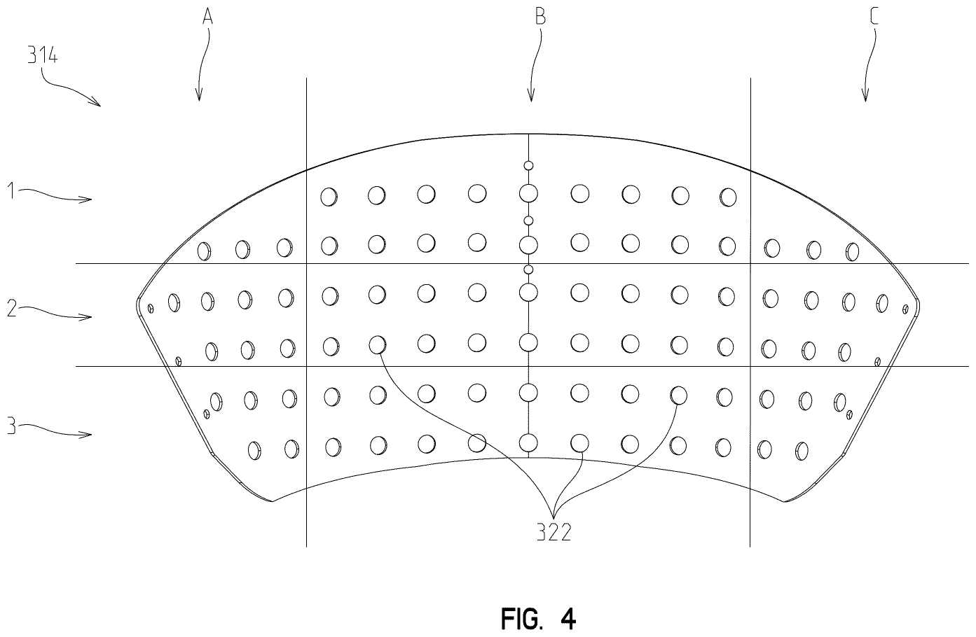

As seen in FIG. 4, one or more sensors 322 may be communicatively coupled to a controller. The one or more sensors 322 may detect an impact and transmit a signal to the controller. The controller may receive the signal(s), assess loading of the louver 314 relative to predetermined criteria, and execute a corresponding response strategy. In one implementation, the controller may be located on or in the harvester 10. However, in other implementations, the controller may be remote from the harvester 10. The controller may be wirelessly coupled to the one or more sensors 322 of FIG. 4. In another implementation, the controller may be hardwired to the one or more sensor 322. The predetermined criteria may include one or more of a threshold value and an optimal loading zone. The threshold value may indicate that disproportionate material is impacting one zone of the louver 314. The optimal loading zone may be a zone on the louver 314 which material is directed towards. The assessment of the loading may include determining how many impacts occurred in each zone, whether the impacts in any zone reached the threshold value, and whether the zone that reached the threshold value was the optimal zone. The corresponding response strategy that may be executed may include providing one or more of a first response (a Tier 1 response), a second response (i.e., a Tier 2 response), a third response (i.e., a Tier 3 response), or no response. An example of different Tier responses when the threshold is detected in Zone 1 (see FIG. 4) are shown in Table 1 below.

TABLE 1
Tier Responses Example (Threshold Reached in Zone 1)

A. Tier 1 Adjustment
1) Decrease Deflector Angle
2) Increase Deflector Length
3) Decrease Fan Speed
B. Tier 2 Adjustment
1) Decrease Harvesting Speed
2) Decrease Chopper Speed
C. Tier 3 Adjustment
1) Decrease Manifold Pressure

Each sensor 322 may detect an impact from material. In some implementations, each sensor 322 may detect the force applied by the material to the sensor 322. The one or more sensors 322 may be coupled to one or more controllers. In one implementation, the controller may be located on or in the harvester 10, however the controller may also be remote from the harvester 10. The controller may be wirelessly coupled to the one or more sensors 322. In another implementation, the controller may be hardwired to the one or more sensor 322. The controller may receive the signal(s) from the one or more sensors 322, assess the loading of the billet louver 314 relative to predetermined criteria, and execute a corresponding response strategy or method. The controller may include a memory unit and processor unit. The memory unit may be capable of storing algorithms, processes, programs, software, look up tables, data, charts, diagrams, etc.

Still referring to FIG. 3, there may be an air void near the louver 314 because the louver 314 may at least partially block or alter the flow of air. This may be detrimental because some extraneous plant matter may not be separated from the crop billet B due to this air void. The air void on the rear of the basket/collection chamber may prevent sufficient airflow from contacting the incoming mat of cut cane. This can decrease the probability of separating leaf matter from billets as the cane mat approaches the louver and enters the basket 316. Therefore, a charged air attachment 330, may be coupled to the harvester 10 in the vicinity of the billet impact zone associated with the louver 314 to promote separating the extraneous plant matter from the crop billet B. In other implementations, a charge air attachment is located at predetermined locations of the conveyor 84, for instance prior to the secondary separator 88.

FIG. 4 illustrates the louver 314 with the one or more sensors 322. In this implementation, the louver 314 with sensors 322 may be divided into different zones. For example, the louver 314 may be separated into a top horizontal zone 1 as illustrated by arrow 1 in FIG. 4 (hereinafter “zone 1”), a bottom horizontal zone 3 as illustrated by arrow 3 in FIG. 4 (hereinafter “zone 3”) located below zone 1, and a middle horizontal zone 2 as illustrated by arrow 2 in FIG. 4 (hereinafter “zone 2”) located between zone 1 and zone 3. In other examples, there may be less than three horizontal zones. In some examples, there may be more than three horizontal zones. The louver 324 may also be separated into vertical zones, such as vertical zone A as illustrated in by arrow A in FIG. 4 (hereinafter “zone A”), vertical zone B as illustrated by arrow B in FIG. 4 (hereinafter “zone B”) and vertical zone C as illustrated by arrow C in FIG. 4 (hereinafter “zone C”).

The horizontal zones may intersect with the vertical zones. For example, in FIG. 4, zone 1 may intersect with zone A, and this area of the louver 314 may be referred to as zone 1A. Zone 1 may also intersect with zone B, and this area of the louver 314 may be referred to as zone 1B. Zone 1 may also intersect with zone C, and this area of the louver 314 may be referred to as zone 1C. Similarly, zone 2 may intersect with the vertical zones. Zone 2 may intersect with zone A, and this area of the louver 314 may be referred to as zone 2A. Zone 2 may also intersect with zone B, and this area of the louver 314 may be referred to as zone 2B. Zone 2 may also intersect with zone C, and this area of the louver 314 may be referred to as zone 2C. Finally, Zone 3 may intersect with the vertical zones. For example, zone 3 may intersect with zone A, and this area of the louver 314 may be referred to as zone 3A. Zone 3 may also intersect with zone B, and this area of the louver 314 may be referred to as zone 3B. Zone 3 may also intersect with zone C, and this area of the louver 314 may be referred to as zone 3C.

Although the illustrative implementation of FIG. 4 has three horizontal zones, other implementations may include one horizontal zone, two horizontal zones, four horizontal zones, or five or more horizontal zones. Likewise, while FIG. 4 has three vertical zones, other implementations may include one vertical zone, two vertical zones, four vertical zones, or five or more vertical zones. While FIG. 4 illustrates the zones with a particular number of sensors 322 in each zone, other implementations may include a different number of sensors in each zone. In other words, any of the zones may include zero sensors 322, one sensor 322, or more than one sensor 322. In one example, the array of sensors 322 may be positioned in one or more rows. In some examples, the array of sensors 322 may be positioned in one or more columns. In another implementation, the one or more sensors 322 may be positioned such that they are not in a row or column configuration. In one implementation, the louver 314 may have an optimal zone and the optimal zone may be located at or near the middle of the louver 314. Directing billet B to impact the optimal zone of the louver 314 may promote cleaning extraneous plant matter from the crop billet B.

In FIG. 4, for example, the optimal zone may include zone 2B. The optimal zone is defined as a location on the louver 314 where there is a balance between billet losses and trash or extraneous material extraction. Each of the sensors 322 transmits sensor signals that indicate the number of impacts experienced in each zone, including billet impacts. The number of impacts may be compared to an impact threshold which is used to identify which zone or zones receive the most billet impacts from billets moving through the chamber and into the louver 314. The number of impacts may be used to adjust air flow transmitted by the charged air attachment 330 to change billet direction and therefore the number of billet impacts in one or more of the zones.

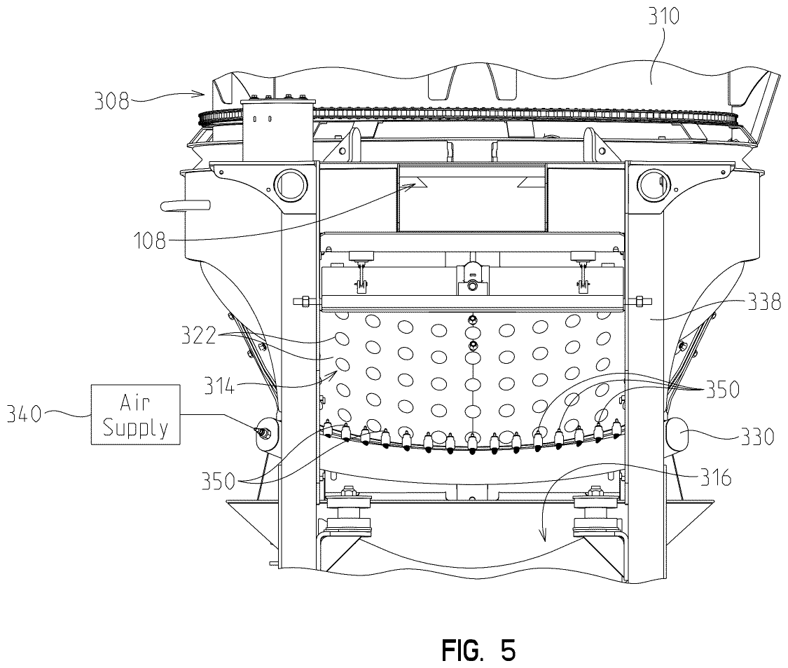

Referring now to FIG. 5, the charged air attachment 330 is coupled toward a bottom portion of the to the louver 314, which includes the sensors 322. The charged air attachment 330 and/or louver 314 are coupled to a frame 338 which also supports the primary separator 308 having the hood 310. Charged air refers to air that is compressed or pressurized and delivered by an air supply 340 to the charged air attachment 330. The air supply 340 may include an air compressor, a blower, a fan, or any other mechanism that may deliver air, which may be compressed, to the charged air attachment 330. In different implementations, the charged air attachment 330 is coupled to the louver, to the basket, to a frame supporting the louver or the basket, or around a periphery of the basket.

The charged air attachment 330 may have one or more nozzle assemblies 350 and the charged air may exit the one or more nozzle assemblies 350 thereby promoting cleaning and separating the extraneous plant matter from the crop billet B. The one or more nozzle assemblies 350 may be positioned to point in an upward direction. In some implements the one or more nozzle assemblies 350 may point towards the fan 108 (see FIG. 2).

In some implementations, the charged air attachment 330 may include separate and distinct charged air attachments or a single charged air attachment 330, each having a plurality of nozzles or nozzle assemblies. In one implementation, each charged air attachment includes up to five or more nozzle assemblies. In implementations having multiple charged air attachments, each attachment may be positioned to direct air exhausted from the nozzle assemblies 350 to different locations of the louver 314. In several implementations, the charged air attachment 330 includes a plurality of the nozzle assemblies 350. If the charged air attachment 330 is configured as multiple separate and distinct charged air attachments, each of the individual charged air attachments may have one or more nozzle assemblies 350. If more than one charged air attachment is provided, each of the charged air attachments may be arranged end to end. In other implementations, the individual charged air attachments may be located in rows or staggered. In a further implementation, one or more of the nozzles is oriented to direct air flow towards different areas of the crop billet mat of harvested material. In this way, one or more impact zones are configured to generate distinct zones of impacting air at the crop billet mat. Each of the nozzles may be oriented individually or in groups in a predetermined direction to provide different zones of impact. The zones may include, but are not limited to, the left, the right, or the center of the moving crop billet mat. In one implementation, the orientation of each of the nozzles may be actuated by an actuator. In other implementations, the orientation of each of the nozzles may be fixed.

In one example, the one or more nozzle assemblies 350 may all be either delivering air (on) or not delivering air (off). A solenoid (not shown), for example, may electronically control whether the nozzle 350 is on or off. In some implementations, each nozzle 350 may be individually controlled to turn on or off. In some implementations, two or more nozzle assemblies 350 may be linked or fluidly coupled such that when one of the two or more fluidly coupled nozzle assemblies 350 is on, the other fluidly coupled nozzle assemblies 350 is on. Moreover, when one of the fluidly coupled nozzle assemblies 350 is off, the other fluidly coupled nozzle assemblies 350 are off. In some implementations, the air or other fluid may be discharged or sprayed from each nozzle 350 at the same fluid velocity. In one implementation, each nozzle 350 may individually adjust the fluid velocity at which air is released from the nozzle 350. In this implementation, the nozzle assemblies 350 may be individually adjustable to select a desired fluid velocity. In other implementations, individual nozzle assemblies may include fixed nozzles, but one or more of the fixed nozzles include an interior profile selected to provide different fluid velocities. In other implementations, two or more nozzle assemblies 350 may be fluidly coupled, so that the fluid velocity of the air or fluid in one of the fluidly coupled nozzle assemblies 350 is the same as the fluid velocity of the air released from the other fluidly coupled nozzle assemblies 350.

In some implementations, each nozzle 350 may be independently controllable to turn each nozzle on, to deliver a stream of air, or off, to not deliver a stream of air. In some implementations, the one or more nozzle assemblies 350 may be automatically turned on or off via a controller. For example, a controller may energize a solenoid to actuate one or more nozzle assemblies 350 to deliver or not deliver a stream of air. In another implementation, the one or more nozzle assemblies 350 may be actuated to deliver or not deliver a stream of air in response to command or control of an operator. By adjusting the air flow delivered from each nozzle assembly, each nozzle assembly may deliver a unique or individual airflow that is independent relative to the other nozzle assemblies. This further assists with interrupting the incoming crop billets and can better shear off the leaf from the billets prior to contacting the louver. In one implementation, the sensors 322 are operatively connected to the controller and the controller adjusts the air stream of one more of the nozzle assemblies based on detection by the sensors of billets and debris. The detection of the sensors, in different implementations, may be from contact or from location or proximity sensing.

The one or more nozzle assemblies 350 may be moveable relative to the charged air attachment 330. In one implementation, each nozzle 350 may be actuatably coupled, such that if one nozzle 350 moves every coupled nozzle 350 correspondingly moves. In other implementations, two or more nozzle assemblies 350 may be coupled such that when one of the fluidly coupled nozzle assemblies 350 moves each of the other coupled nozzle assemblies 350 move correspondingly. In some implementations, each nozzle 350 may independently movable. In some implementations, the one or more nozzle assemblies 350 may be automatically moved via a controller. For example, a controller may energize a solenoid to actuate or move the one or more nozzle assemblies 350. In another implementation, the one or more nozzle assemblies 350 may be moved by the command or control of an operator. By adjusting each nozzle, e.g., its orientation or angle, the nozzle dispenses a unique or individual airflow that is independent relative to the other nozzle assemblies. This orientation assists with interrupting the incoming crop billets and may provide in improved shear off, i.e. separation, of the leaf matter from the billets prior to contacting the louver 314.

In one example, the charged air attachment 330 may have a length that extends from a first side of the louver to a second side of the louver 330. In one example, the length of the charged air attachment 330 may extend beyond one or more of the first side or the second side.

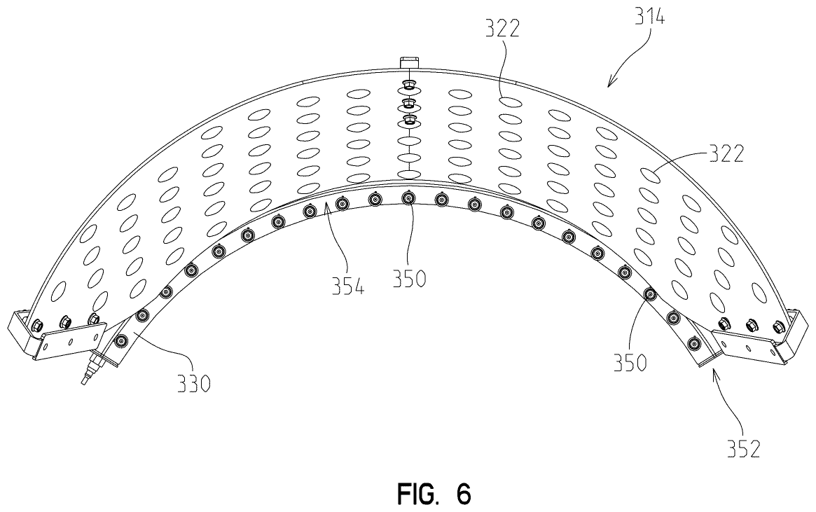

FIG. 6 illustrates the charged air attachment 330 located at a bottom edge 352 of the louver 314. In this implementation the louver 314 is curved. As seen in FIG. 6, the air attachment 330 includes a profile which substantially corresponds to the bottom edge 352 of the louver 314. The bottom edge 351 and the air attachment 330 each define a curved form such that there is no gap or a minimal gap between the bottom edge of the lover 314 and the air attachment 330. In this implementation, the air attachment 330 includes a curved tube 354 from which the nozzle assemblies 350 extend. Each of the nozzle assemblies 350 extend from a top centerline of the curved tube 354 which provides a curved surface of the tube 354 on either side of a line of nozzle assemblies 350. In one implementation, the curved bottom edge 352 of the louver 314 is located adjacent to the line of nozzle assemblies 350 such that the some or all of the nozzle assemblies 350 extend past the bottom edge 352. In further implementations, the louver 314 includes one or more planar sections coupled together to for the louver 314. In addition, individual curved sections may be coupled together to form a complete louver.

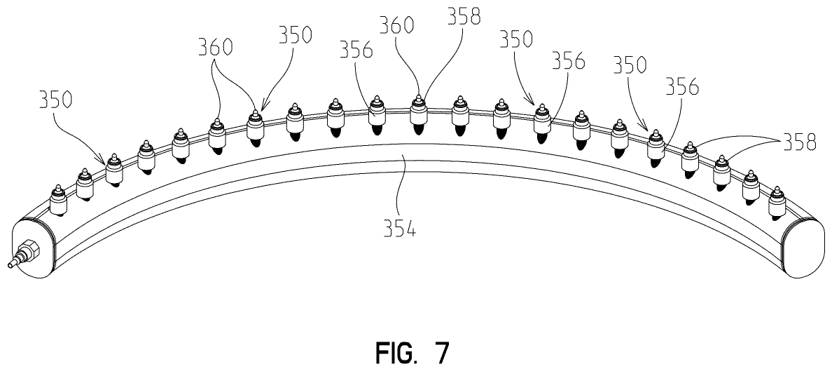

FIG. 7 illustrates a portion of the plurality of nozzle assemblies 350, each of which extends from the tube 354. Each of the nozzles 350 includes a nozzle sleeve 356 which is operatively connected to the tube 354. In different implementations, the nozzle sleeve 356 is fixedly connected to the tube 354 through threads located on the tube 354 and threads located on at the nozzle sleeves 356. Other techniques to couple the sleeve to the tube, such as welding or soldering, are contemplated. Each of the nozzle assemblies 350 further includes a converging-diverging nozzle 358 having a tip 360. As described herein, a converging-diverging nozzle is also described as a supersonic nozzle. The converging-diverging nozzle 358 receives air delivered to the nozzle by the tube 354 and accelerates the received air moving through the nozzle 358.

Momentum imparted to extraneous plant matter is directly dependent upon the mass and velocity of impinging airflows. Currently, for a given pressure source, a velocity “ceiling” will be hit when the flow becomes choked. By introducing a converging-diverging nozzle, i.e. the converging-diverging nozzle 358, the upper limit of available momentum gets increased without substantially increasing the power requirements of the cleaning system. This configuration enables higher air velocities and allows the effective distance of the air flow delivered by the nozzle to be increased. By providing pressurized gas, i.e. air, to the converging side of the supersonic nozzle 358, the gas will be accelerated until it reaches sonic velocity, at this point further constriction of the passageway will not result in greater velocity at the exit. In order to continue accelerating the flow, the gas is passed into a diverging nozzle. The exit velocity of the gas is determined by the cross-sectional area ratio of the throat to the outlet, with the understanding that the pressure must be held above the critical pressure ratio to prevent the diverging portion of the nozzle from acting as a diffuser which may reduce the velocity of the flow. The effective distance of these nozzles is driven by the mass and exit velocity of the air stream. By generating supersonic air flow, the one or more supersonic nozzles 358 break up the crop flow through the machine, to more effectively separate the extraneous matter from the billets. More momentum is thereby imparted to the extraneous matter, also known as leaf litter or trash, allowing the extraneous matter to be separated from the heavier sugarcane billets, by the primary extractor fan or by ejecting the trash from the elevator directly, such as elevator 84.

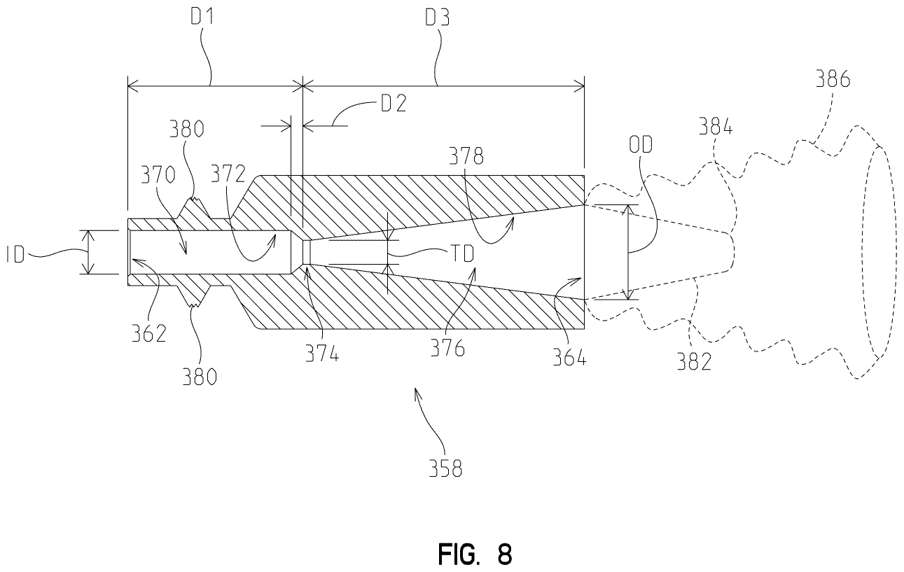

In one implementation, the supersonic nozzle 358 includes an inlet 362 and an outlet 364 as further illustrated in FIG. 8. The supersonic nozzle 358, in one implementation, includes threads that engage threads of the nozzle sleeve 356. The nozzle outlet 364 is located at the tip 360. The supersonic nozzle 358, due to its threads enables a defective supersonic nozzle 358 to be replaced, if needed, without requiring further modifications to other nozzle sleeves 356 or to other nozzles 358. In other implementations, the nozzle sleeve 356 and supersonic nozzle 358 are combined as a unitary nozzle such that replacement or repair of the nozzle assembly 350 includes the use of a unitary part which is not separable into separate components.

The inlet 362 is disposed adjacently to an inlet chamber 370 which receives pressurized air provided from the air supply 340 and which moves through the air attachment 330 to the inlet 362. The inlet 362 includes an inlet distance ID which defines the distance across the diameter of the section 370. The section 370 is a converging chamber that includes an interior surface 372 which converges at a throat 374. The throat 374 is located at a transition between the inlet 362 and a diverging chamber 376 having an interior surface 378. The throat 372 includes a throat distance TD after which the interior wall 378 of the diverging chamber 376 expands to the outlet 364. The outlet 364 includes an outlet distance OD. The supersonic nozzle 358 includes a distance D1 between the inlet 362 and the converging section, a distance D2 between the converging section and the throat 372, and a distance D3 between the throat 372 and the outlet 364. In one or more implementations, the supersonic nozzle 358 includes threads 380 that engage threads of the nozzle sleeve 356.

During operation, the supersonic nozzle 358 receives forced air or pressurized air at inlet 362. The forced air supplied to the inlet is greater than ambient pressure and slower than supersonic or where M is less than 1 [M<1], with 1 [M=1] being a sonic flow. As used herein, M=velocity/speed of sound (through a medium). The forced air generates a supersonic air flow from the throat through the supersonic exhaust zone 382 at the outlet 364, where the supersonic flow has a Mach number greater than 1, or M greater than 1. The supersonic exhaust zone 382 is conical in shape having a base at the outlet 364 and a tip 384 where the zone defines a vertex of a cone. Within the exhaust zone 382, the air flow is supersonic and widest at the outlet 364 and narrows at the tip 384. In one implementation, since zone 382 is configured to include a focused exhaust with a higher velocity, the direction and location of nozzles may be based on the identified velocity.

An air flow area 386 expands outwardly from the outlet 364 and includes the supersonic air flow 382. Consequently, while air flow within the air flow area 386 is greater than ambient pressure, the air flow within the supersonic exhaust zone 382 provides the greatest cleaning and separating force to separate the extraneous plant matter from the crop billet B. During and after separation, the extraneous plant matter, which is generally lighter than the cut billets, is moved by the fan 108 to the hood outlet 132 for dispersal. The supersonic flow profile provides a point source flow pattern with finite intense air streams which enables a more efficient removal of the leaf trash/leaf shearing process without lifting the cut billets further into the cleaning chamber which can generate potential field losses. Area sources with broader applications/flow patterns tend to provide undesirable field losses and potentially consume more power. The heavier cut billets B fall into the basket 316. The positioning of the nozzles, therefore, is optimized to prevent increased billet loss which can be compared to existing implementations of sub-sonic forced air cleaning systems methods. For example, any substantial increase in vertical billet velocity in the front of the cleaning chamber can increase the billet losses, by allowing the billets to dwell in the increased upwards flow of the primary extractor fan and getting sucked up into the fan. Since the speed of the supersonic airflow may be determined, at least in part by the configuration of the nozzles, the structure of the nozzles may be selected to reduce the energy consumed by the system. By reducing the outlet air flow velocity, the position and/or direction of the nozzles is determined to provide optimized cleaning with reduced airflow.

In one implementation, the front portion of the cleaning chamber has a high air velocity concentration as the rear portion has lower velocities. A preferred orientation, position, and air velocities needed to both promote billet/leaf separation and to not add/increase the vertical billet velocities which may promote billet losses are provided. Moreover, the finite air streams created by the supersonic flow from the nozzles allows shearing of the leaf material to occur with great efficiency without further lifting the cut billets higher into the cleaning chamber.

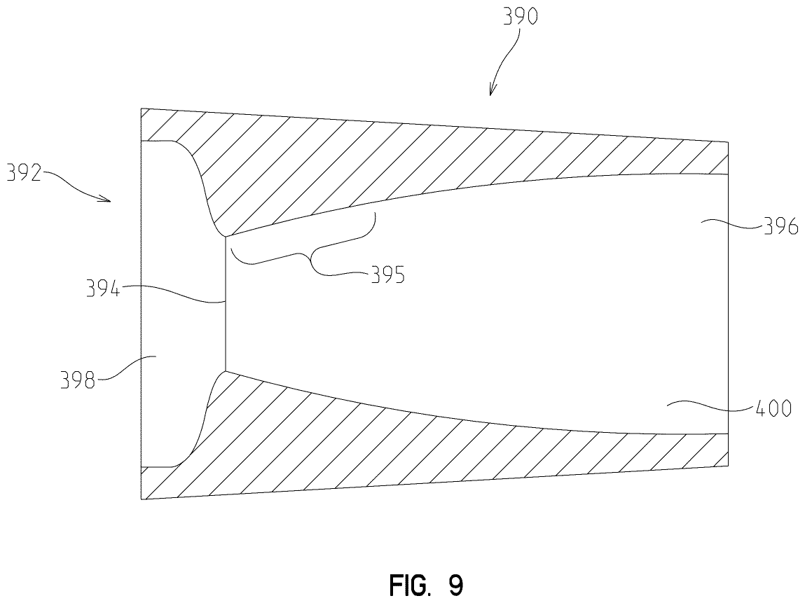

FIG. 9 illustrates another implementation of a supersonic nozzle 390 having an inlet 392, a throat 394, and an outlet 396. An inlet chamber 398 is located between the inlet 392 and the throat 394 and an outlet chamber 400 is located between the throat 394 and the outlet 396. The inlet chamber 398 diverges toward the throat 394 and the outlet chamber 400 diverges away from the throat 394. While nozzle 390 may be configured to provide similar performance as nozzle 358 of FIG. 8, the internal geometry of each nozzle determines the outlet velocity. For instance, in one implementation the internal geometry of nozzle 358 is generally linear. In another implementation, the configuration of a parabolic expanding section 395 may lead to less diffusion at a given distance from the outlet. As seen in FIG. 9 the parabolic expanding section 395 is illustrated to include an interior sidewall 397 extending from the throat 394 toward the outlet 396. The interior surface of the section 395 includes the parabolic expanding section 395. In one or more implementations, the parabolic expanding section 395 may include portions having one or more lengths of the interior surface of the sidewall 397, including extending from the throat 394 to the outlet 396.

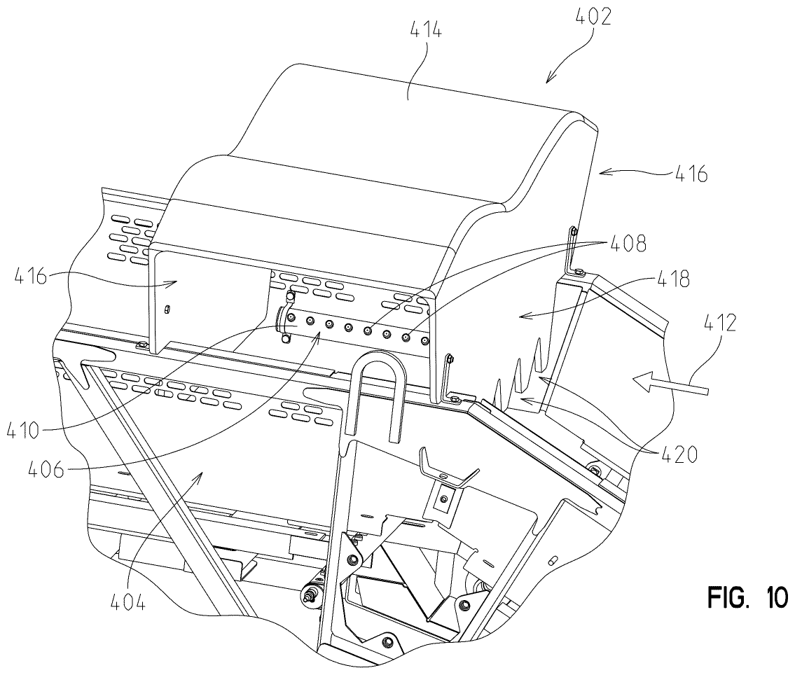

The parabolic expanding section configuration may achieve less diffusion and provide a greater exhaust length, by making section 384 longer and section 386 thinner of FIG. 8. In another implementation, a plug 408 is welded into the manifold as seen in FIG. 10. In one implementation of the nozzle 390, the nozzle 390 may be more space efficient due to its lack of a long inlet section 370 of FIG. 8. The outer geometry of nozzle 390 includes a generally cylindrical shape configured to be welded to the charged air attachment.

The cost of production for supersonic nozzles is considered to be similar to the cost of existing subsonic nozzles when created at production quantities. Options for manufacture include additive manufacturing, casting, and machining. One or more types of materials are considered to be viable for the design and are selected based on positioning and location of the supersonic nozzles as well a mechanical analysis to determine stress response and safety factors.

Equations governing airflow analysis, for reference, include but are not limited to: 1) Mach number ME=V/a; where a=sonic velocity in the medium, V=velocity of the medium; 2) Mach number at a point (i) M_i=V_I/(gamma*g*R*T_i)\hat{ }0.5; 3) Mass Flow rate through cross-sectional area m′=p*A*M*((y*g)/(R*T))\hat{ }0.5=constant; maximum at A_star; 4) Converging nozzle outlet velocity V_2=((2*y)/(y+1)*P_in*v_1)\hat{ }0.5; 5) Converging Nozzle critical pressure ratio r_c=2/(gamma+1))\hat{ }(gamma/(gamma−1))=P_in/P_out.

Equations governing nozzle geometry include but are not limited to: Expansion Ratio (A/A_throat)A/A_star=1/M*(1+(y−1)/2*M\hat{ }2)/((y+1)/2))\hat{ }((y+1)/(2*(y−1)))

In the present disclosure, there may be different air sources used at different locations to promote leaf separation, enhance trash extraction, reduce billet losses, etc. In one example, charged or compressed air is a more concentrated, intense air stream emitted from air source that imparts on the incoming billet stream stronger impact forces that would allow the air flow to manipulate the trajectory of the billets and allow for the leaf to be separated from the billet. While higher forces are generated via the charged or compressed air, the air stream output is narrower and may not interact with as much material as intended on the mat. In another example, blowers and fans may be utilized in a broader application by impacting more of the material in the mat, but with lesser intensity than the charged or compressed air. As a result, the blower and fans may have less ability to dislodge the leaf from the incoming billet. In other examples, charged or compressed and crossflow (e.g., blowers or fans) may be used in combination to facilitate greater leaf extraction and billet cleaning.

Moreover, charged or compressed air may provide high intensity concentrated air streams with higher impact forces over greater effective lengths from the nozzles. Axial or cross flow or prop driven fans may provide lower intensity streams with a wider, shorter coverage. Supplemental air in the rear portion of the cleaning chamber uses louver impact of billet leaf unit to further separate leaf trash from severed billets, eliminates an air void due to the louver, and provides for a low risk of billets losses in the rear portion due to a downward trajectory of cane mat. Supplemental air in the front portion of the cleaning chamber directs the cane mat into the extended deflector, and this impact with additional airflow promotes billet leaf separation. In the same way, the supplemental air in the front portion prevents the lower portion of the cane mat from nose diving into the basket after the mat contacts the billet deflector. Once the crop is static, no further leaf separation occurs. Further, there is a lack of air voids on the front portion of the cleaning system. The supplemental air source will work in tandem with the extended billet deflector to promote billet leaf unit impacts on the louver.

In some implementations of the present disclosure, it is desirable to agitate the crop, promote the mat to travel the full trajectory, and to provide additional airflow at key spots along the trajectory. With supplemental air on the sides and periphery of the basket, this supplemental air will contribute to both the functionality of the rear and front air flows.

In another implementation, the crop is agitated at an elevator transition system 402 as illustrated in FIG. 10. The location of the elevator transition system 402 may be located at location 404 of FIG. 2. The elevator transition system 402 includes an elevator charged air attachment 406 including a plurality of supersonic nozzles 408. In this implementation, the elevator charged air attachment 406 includes a straight tube 410 from which the nozzle assemblies 408 extend. The attachment 406 is aligned with a flow of the cane mat as it travels along the elevator along direction 412. In other implementations, the charged air attachment 406 is inclined with respect to the direction 412, for instanced generally perpendicular to direction 412. In further implementations, two or more charged air attachments may be located at location 404, in one or more directions with respect to the direction 412.

The elevator transition system 402 includes a transition hood 414 coupled to the elevator at location 404 which provides a guard for the sugarcane mat which is configured to direct debris from the mat as the mat moves along the elevator. The transition hood 414 extends between sides of the elevator and includes openings 416 through which crop debris is directed. An entrance side wall 418 includes slots 420 to direct the mat through the transition hood 414. In one implementation, the slots 420 to direct crop debris through the openings 416.

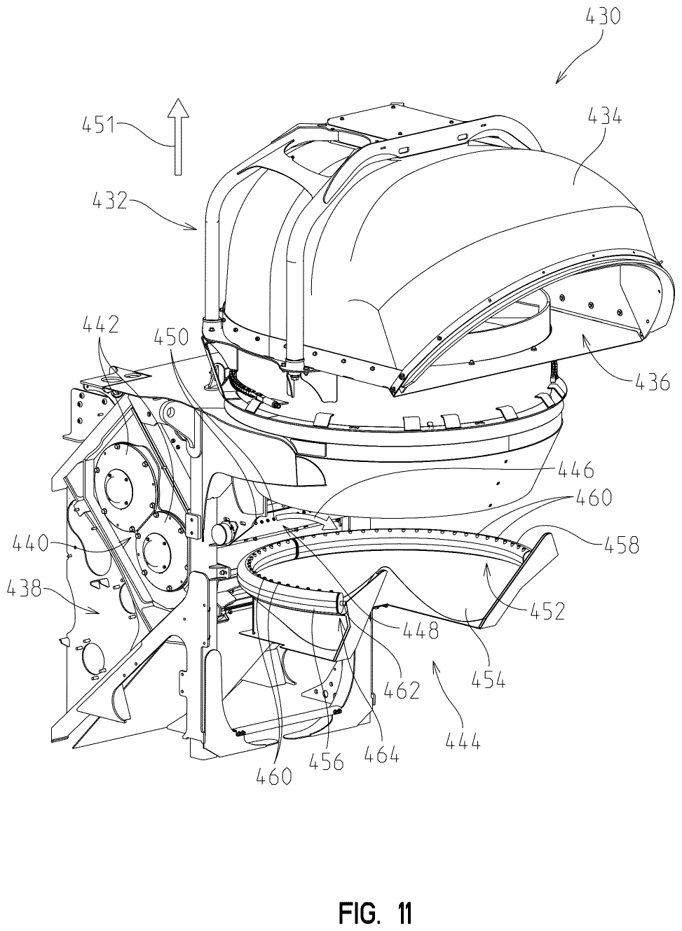

FIG. 11 is a perspective side view another implementation of a cleaning system 430 of the sugarcane harvester. The cleaning system 430 includes a primary separator 432 having a hood 434 defining a primary opening 436. A rear deflector may be included but is not illustrated. Sec FIG. 3 for an example. Feed rollers 438 move the cut crop to a chopper 440. The chopper 440 may include a set of chopper drums 442 driven by a motor. The cut crop is directed to a primary cleaning chamber 444 along a path 446 that extends from the chopper 440 across a charged air attachment 448. The charge air attachment 448 includes a plurality of supersonic nozzles 450 extending from and aligned in a row extending from one end of the air attachment 448 to a second end of the air attachment 448. In one implementation, the air attachment 448 is aligned generally perpendicular to the flow of cut crops. Other directions of alignment are contemplated. In one implementation, the supersonic nozzles 450 are directed toward the primary cleaning chamber 444 by being inclined with respect to a vertical axis 451 of the cleaning system 430.

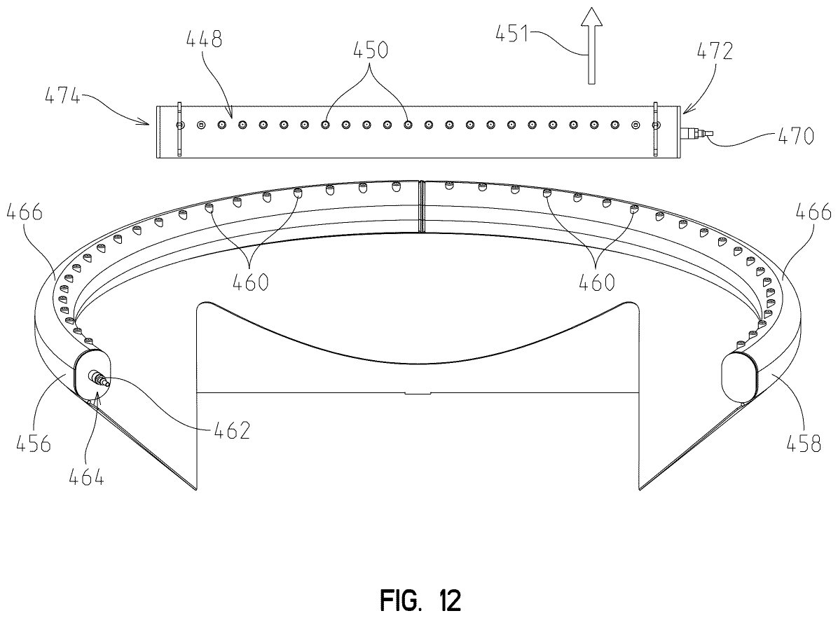

A second charged air attachment 452 is located adjacent to a housing 454 of the primary cleaning chamber 444. In one implementation, the housing 454 is bowl shaped with a generally circular edge. The second charged air attachment 452 includes a first manifold 456 and a second manifold 458 each of which includes a plurality of supersonic nozzles 460. As seen in both FIG. 11 and FIG. 12, the second charge air attachment 452 is generally circular and follows the generally circular edge of the housing 454. Each of the first and second manifolds 456 and 458 terminate at the rear deflector, not shown. While two manifolds are illustrated, a single manifold or more than two manifolds may be implemented in the cleaning system 430.

Each of the first manifold 456 and second manifold 458 supports a plurality of supersonic nozzles 460, which in one implementation, is configured to included that same features as the supersonic nozzles 450. In other implementations, the nozzles 460 may include features that are different than the supersonic nozzles 450. In one implementation for instance, nozzles having different outlet air velocities and/or exhaust lengths may be situated at strategic locations in the cleaning chamber/elevator to provide the same overall effects. By intercepting the crop at certain intervals along the crop trajectory with targeted airflows, provides the “leaf shearing effects” while not promoting “billet lifting” actions. For example, lower air velocities/exhaust lengths may be provided in the front portion of the cleaning chamber. Where as, the rear portion needs higher air velocities/exhaust lengths. A fluid inlet 462 is coupled to an end 464 of the first manifold 456 and receives pressurized fluid such as air directed to and through each of the manifolds to the nozzles 460. Each of the manifolds 456 and 458 include a centerline 466. The nozzles 460, in the illustrated implementation, are offset from the centerline 466 and are generally parallel to the vertical axis 451. In other implementations, the nozzles 460 may be inclined with respect to the vertical axis 451. The charged air attachment 448 includes a fluid inlet 470 coupled to an end 472 thereof. The charged air attachment 448 includes a terminating end 474 A single fluid blower, not shown, may be coupled to both the fluid inlet 462 and 470. In other implementations, each of the fluid inlets 462 and 470 may receive charged air from separate fluid blowers.

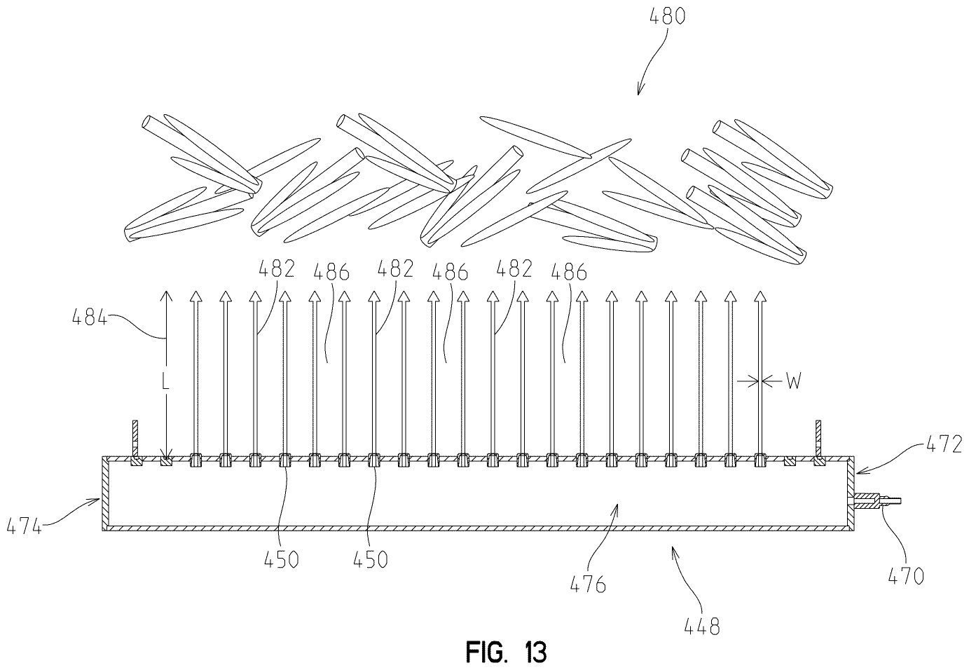

FIG. 13 illustrates a schematic representational view of airflow generated by each of the nozzles 450 of the charged air attachment 448. The charged air attachment 448 is shown in a cutaway view and includes a chamber 476 defined by the end 472 and the terminating end 474. Charged air directed through the fluid inlet 470 enters the chamber 476 and enters each of nozzles 450 after which the charged supersonic air is expelled from each of the supersonic nozzles 450 to a cane mat 480. As the cane mat 480 crosses over the line of nozzles 450, crop debris is separated from the cut crop, i.e. billets, to provide a cleaned cut crop.

Each of the nozzles 450, due to their supersonic design, generates a relatively uniform supersonic or hypersonic airflow 482. The hypersonic airflow 482 from each of the nozzles 450 includes a linear symmetry having a generally fixed width along a length 484. The length 484 is defined to include an effective range which is defined by a length of the charged air attachment 448, an internal dimension of the chamber 476, the number of nozzles 450, nozzle dimensions, and the charged airflow introduced to the inlet 470. The airflow 482 from each of the nozzles 450 include a generally narrow cylindrical form along the length 484, wherein a space 486 of little or no air flow is located between each of the air flows 482. The narrow cylindrical form includes a width W such that the width W remains relatively constant along the length 484 until it reaches and impinges upon the cane mat 480.

While the airflow 482 of each of the nozzles 450 tends to expand and overlap at a certain distance from the nozzles 450, the length L is selected to include an effective length where airflow overlap is nonexistent or negligible when impinging upon the mat 480. Consequently, a narrow high pressure supersonic airflow from each nozzle includes a distinct point of airflow that is separate from adjacent air flows. The use of hypersonic airflow provides a point flow at the area of impingement with the mat as opposed to an area flow where adjacent nozzle airflows overlap. The airflow points of contact with the mat separates debris from the cut crop more effectively and more completely when compared to airflows that are less than hypersonic and which overlap. Thus, high speed hypersonic airflow not only provides a more complete separation of debris from the mat, but may also strip unneeded vegetation, such as leaves, from the cut billets. Cleaning of cut sugarcane crop is therefore improved which may improve profitability.

While the discussion of FIG. 13 is directed to the air attachment 448, this discussion applies equally as well to the second charged air attachment 452, as well as other air attachments including different configurations. These configurations include but are not limited to air attachments having different lengths, different geometries, and different locations at the primary cleaning chamber 444 and at the elevator 84.

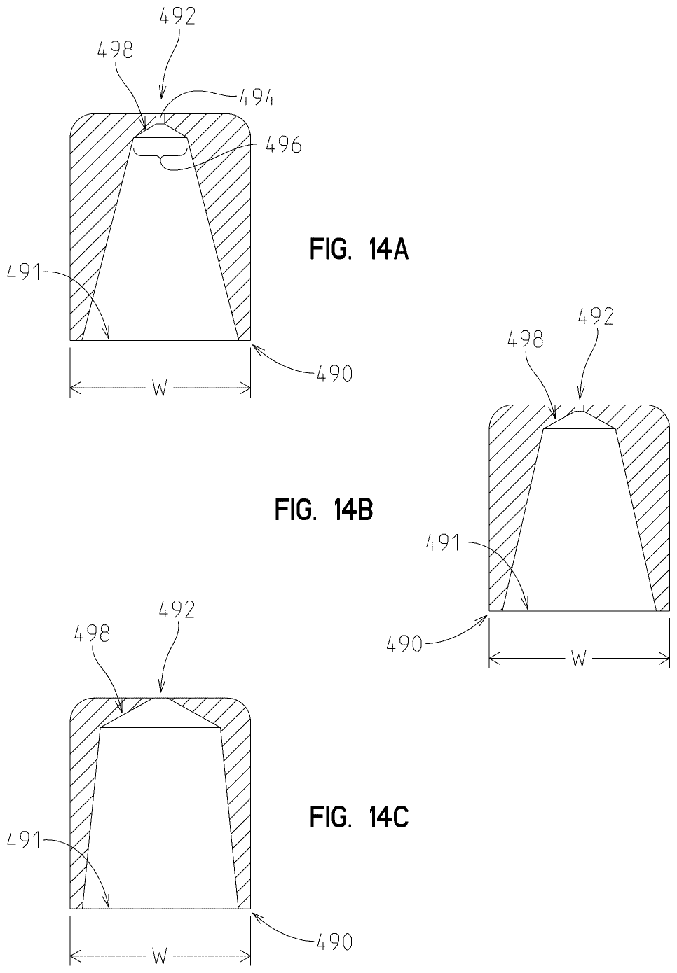

FIGS. 14A-14C illustrate additional implementations of supersonic nozzles 450 and/or supersonic nozzles 460. Each of the nozzles is identified as nozzle 450 for case of illustration and include a base 490 having a width W. The base 490 is an inlet 491 and receives charged air. Each of the nozzles 450 further includes an outlet 492 including a throat 494. In one or more implementations, each nozzle 450 includes a width of similar sizes but having a cone-shaped sidewall that converges to a throat width 496 at a converging section 498. The throat widths 496 of the converging sections 498 may include different widths.

While air is generally described herein as the fluid discharged by the air attachment in this disclosure, it is to be understood in some implementations other types of fluid (gas or combination thereof) may be used.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. A sugarcane harvester for harvesting a sugarcane crop including stalks of sugarcane comprising:
a chopper configured to chop the sugarcane crop into crop billets for discharge into a cleaning chamber;
a primary separator comprising a housing and a fan positioned in the housing to induce a primary flow of air to separate extraneous plant matter from the crop billets, the housing including a housing inlet through which the primary flow of air enters the housing;
a louver located in the housing to deflect the crop billets into a basket; and
a supplemental air attachment located in the housing opposite of the chopper and configured to direct an accelerated flow of air towards the louver to separate the extraneous plant matter from the crop billets.

2. The sugarcane harvester of claim 1 wherein the supplemental air attachment is coupled to the louver.

3. The sugarcane harvester of claim 1 wherein the supplemental air attachment is coupled to the basket.

4. The sugarcane harvester of claim 3 wherein the supplemental air attachment is coupled at a periphery of the basket.

5. The sugarcane harvester of claim 1 wherein the supplemental air attachment includes one or more converging-diverging nozzles, each of which discharges the accelerated air flow.

6. The sugarcane harvester of claim 5 wherein the accelerated air flow is a supersonic airflow delivered at an outlet of the one or more converging-diverging nozzles.

7. The sugarcane harvester of claim 6 wherein each one of the one or more converging-diverging nozzles is independently controlled between an off state where no air flow is delivered from the outlet converging-diverging nozzle and on state where the accelerated air flow is delivered from the outlet of the converging-diverging nozzle.

8. The sugarcane harvester of claim 6 wherein each of the one or more converging-diverging nozzles is independently controlled between an off state where no air flow is delivered from the outlet converging-diverging nozzle and an on state where the accelerated air flow is delivered from the outlet of the converging-diverging nozzle.

9. The sugarcane harvester of claim 6 wherein each of the one or more converging-diverging nozzles is independently controlled to deliver accelerated air flows having different velocities.

10. The sugarcane harvester of claim 5 wherein the louver includes a plurality of sensors to detect billet impacts and a controller adjusts the accelerated air flow of one or more of the nozzles based on the detected billet impacts.

11. A cleaning system for a sugarcane harvester, comprising:
a primary separator comprising a housing and a fan for providing a primary flow of air into the housing, the housing including an opening defined at a front portion thereof configured to receive a crop billet mat that is chopped by a chopper and discharged into the housing along a first flow path;
a billet deflector located in the housing adjacent the opening, the billet deflector configured to deflect the crop billet from the first flow path to a second flow path;
a louver located in the housing and along the second flow path, the louver configured to redirect the crop billet from the second flow to a third flow path in the housing;
a basket located in the housing and at a location below the louver, the basket positioned along the third flow path to receive the crop billets from the louver; and
a supplemental air attachment located in the housing, the supplemental air attachment configured to direct an accelerated flow of air towards the crop billet mat to separate the extraneous plant matter from the crop billets.

12. The cleaning system of claim 11 wherein the supplemental air attachment is coupled to the louver.

13. The cleaning system of claim 11 wherein the supplemental air attachment is coupled to the basket.

14. The cleaning system of claim 13 wherein the supplemental air attachment is coupled at a periphery of the basket or to an elevator.

15. The cleaning system of claim 11 wherein the supplemental air attachment includes one or more converging-diverging nozzles, each of which discharges the accelerated air flow.

16. The cleaning system of claim 15 wherein the accelerated air flow is a supersonic airflow delivered at an outlet of the one or more converging-diverging nozzles.

17. The cleaning system of claim 16 wherein each one of the one or more converging-diverging nozzles is independently controlled between an off state where no air flow is delivered from the outlet converging-diverging nozzle and on state where the accelerated air flow is delivered from the outlet of the converging-diverging nozzle.

18. The cleaning system of claim 16 wherein each of the one or more converging-diverging nozzles is independently controlled between an off state where no air is delivered from the outlet converging-diverging nozzle and an on state where the accelerated air flow is delivered from the outlet of the converging-diverging nozzle.

19. The cleaning system of claim 16 wherein each of the one or more converging-diverging nozzles is independently controlled to deliver accelerated air flows having different independently controlled nozzle orientations.

20. The cleaning system of claim 15 wherein louver includes a plurality of sensors to detect billet impacts and a controller adjusts the accelerated air flow of one or more of the nozzles based on the detected billet impacts.
